(19) United States
(12) Patent Application Publication
(10) Pub. No.: US 2013/0108481 A1
(43) Pub. Date: May 2, 2013

(54) Wearable Fan Assembly And A Method Including The Same

(71) Applicant: Lawrence G. Hoye, Grove City, OH (US)

(72) Inventor: Lawrence G. Hoye, Grove City, OH (US)

(21) Appl. No.: 13/403,935

(22) Filed: Feb. 23, 2012

Related U.S. Application Data
(60) Provisional application No. 61/552,393, filed on Oct. 27, 2011.

(51) Int. Cl. F04D 19/00; B23P 11/00

(52) U.S. Cl. 417/234; 29/428

(57) ABSTRACT

A wearable fan assembly including a fan housing having a base portion, the base portion having a bottom surface with at least one magnet disposed thereon; a power source disposed in the base portion of the fan housing; a plurality of fan blades pivotally disposed about a rotational axis; a motor for driving the fan blades during an operational state of the fan assembly, the motor operatively coupled to the power source in the base portion of the fan housing; and a detachable component configured to matingly engage with the at least one magnet disposed on the bottom surface of the base portion of the fan housing. When the wearable fan assembly is attached to an article of clothing worn by a user, a portion of the article of clothing is sandwiched between a bottom surface of the at least one magnet and a top surface of the detachable component.

### CROSS-REFERENCE TO RELATED APPLICATIONS

This patent application claims priority to, and incorporates by reference in its entirety, pending U.S. Provisional Patent Application No. 61/552,393, entitled “Wearable Fan Assembly And A Method Including The Same”, filed on Oct. 27, 2011.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION BY REFERENCE OF MATERIAL SUBMITTED ON A COMPACT DISK

Not Applicable.

### BACKGROUND OF THE INVENTION

1. Field of the Invention

The invention generally relates to wearable fan devices. More particularly, the invention relates to a wearable fan assembly that is configured to be attached to an article of clothing worn by a user, and a method including the same.

2. Background and Related Art

Throughout the world, outdoor spectator sports are enjoyed by millions of exuberant fans every year. Although, especially during the summer season in warmer climates, crowded outdoor stadiums tend to get uncomfortably hot for many of their spectators. This is particularly true on days where the sun is shining directly on the spectators in the stadium. In addition to the hot temperatures, stagnant conditions resulting from the lack of air movement in the large, semi-enclosed structures further increase the thermal discomfort experienced by the spectators located therein.

Presently, there is no practical way to effectively cool spectators in such a crowded environment. The typical systems that are used to condition the air in the interior spaces of buildings cannot be reasonably applied to large, open-air stadiums. Also, conventional portable fans containing clamps, braces, and/or straps cannot be effectively utilized in tightly spaced spectator areas because the space constraints and the constant spectator traffic make maneuvering around such devices impractical. In addition, the necklace-type fans that are presently available are not nearly powerful enough to alleviate the heat, nor are they capable of being readily aimed or adjusted.

Therefore, what is needed is a wearable fan assembly configured to be attached to an article of clothing worn by a user that is both generally unobtrusive and comfortable to wear. Moreover, a wearable fan assembly is needed that is powerful enough to generate an airflow that can be readily perceived by a user thereof. Furthermore, a need exists for a wearable fan assembly that is capable of delivering an adjustable stream of air.

### BRIEF SUMMARY OF THE INVENTION

Accordingly, the present invention is directed to a wearable fan assembly that substantially obviates one or more problems resulting from the limitations and deficiencies of the related art.

In accordance with a first aspect of the present invention, there is provided a wearable fan assembly configured to be attached to an article of clothing worn by a user, which includes: a fan housing having a base portion, the base portion of the fan housing having a bottom surface with at least one magnet disposed thereon; a power source disposed in the base portion of the fan housing; a plurality of fan blades pivotally disposed about a rotational axis; a motor for driving the fan blades during an operational state of the fan assembly, the motor being operatively coupled to the power source in the base portion of the fan housing; and a detachable component configured to matingly engage with the at least one magnet disposed on the bottom surface of the base portion of the fan housing. In this embodiment, when the fan assembly is attached to an article of clothing worn by a user, a portion of the article of clothing is sandwiched between a bottom surface of the at least one magnet and a top surface of the detachable component.

In a preferred embodiment of this aspect of the present invention, the detachable component comprises a curved plate.

In another preferred embodiment, the curved plate of the detachable component has a curvature that approximately matches the outer curvature of a limb of the user.

In yet another preferred embodiment, the curved plate of the detachable component is formed from a flexible polymeric material.

In still another preferred embodiment, the detachable component further comprises a metallic material that is magnetically attracted to the at least one magnet, the metallic material being disposed adjacent to a bottom surface of the curved plate.

In yet another preferred embodiment, the detachable component further comprises a backing material substantially covering the bottom surface of the curved plate and a bottom surface of the metallic material.

In still another preferred embodiment, the backing material comprises one of the following: (i) a felt material; (ii) a foam material; and (iii) a sponge material.

In yet another preferred embodiment, the curved plate has an aperture disposed therethrough and the metallic material is positioned behind the aperture.

In still another preferred embodiment, the aperture is smaller in size as compared to the metallic material such that the curved plate overlaps the metallic material on a plurality of its sides, thereby forming a lip.

In yet another preferred embodiment, a top surface of the curved plate is substantially flush with a top surface of the metallic material along at least one outer edge of the metallic material so that the detachable component and the fan housing are capable of being easily detached from one another.

In still another preferred embodiment, the curved plate has either (i) double-stick tape or (ii) hook-and-loop fasteners disposed on a top surface thereof so that the detachable component is capable of being removably attached to the article of clothing.

In yet another preferred embodiment, the at least one magnet comprises two magnets, each being circular in shape.

In still another preferred embodiment, each of the two magnets is attached to the bottom surface of the fan housing by means of a screw.

In yet another preferred embodiment, each of the two magnets is attached to the bottom surface of the fan housing by means of an adhesive.

In still another preferred embodiment, the bottom surface of the fan housing further includes a plurality of feet disposed thereon for enabling the fan assembly to stably rest on a tabletop.

In yet another preferred embodiment, the bottom surface of the at least one magnet is disposed at a higher elevation than a bottom surface of each of the plurality of feet so that the at least one magnet does not affect the stability of the fan assembly when it is resting on the tabletop.

In still another preferred embodiment, the power source disposed in the base portion of the fan housing comprises one or more batteries.

In yet another preferred embodiment, the wearable fan assembly further comprises a power switch for selectively regulating the flow of current from the one or more batteries to the motor.

In still another preferred embodiment, the wearable fan assembly further comprises a power receptacle on the base portion of the fan housing for receiving a plug of an alternating current-to-direct current (AC-to-DC) power adapter.

In accordance with a second aspect of the present invention, there is provided a wearable fan assembly configured to be attached to an article of clothing worn by a user, which includes: a first fan housing portion, the first fan housing portion having a top surface, a bottom surface disposed opposite to the top surface, and a plurality of side surfaces extending between the bottom surface and the top surface, the bottom surface of the first fan housing portion having at least one magnet disposed thereon; a power source disposed in the first fan housing portion; a second fan housing portion rotatably connected to the first fan housing portion; a plurality of fan blades pivotally disposed about a rotational axis, the plurality of fan blades circumscribed by the second fan housing portion; a motor for driving the fan blades during an operational state of the fan assembly, the motor being operatively coupled to the power source in the first fan housing portion; and a detachable component configured to be disposed underneath the bottom surface of the first fan housing portion when the fan assembly is in the operational state, the detachable component comprising a material that is magnetically attracted to the at least one magnet of the first fan housing portion. In this embodiment, when the fan assembly is attached to an article of clothing worn by a user, the bottom surface of the first fan housing portion is configured to be disposed adjacent to an outer surface of the article of clothing, and a top surface of the detachable component is configured to be disposed adjacent to an inner surface of the article of clothing. Also, in this embodiment, the rotational axis of the plurality of fan blades is capable of being oriented in a direction that is substantially parallel to an extending direction of the bottom surface of the first fan housing portion when the fan assembly is in the operational state.

In accordance with a third aspect of the present invention, there is provided a wearable fan assembly configured to be attached to an article of clothing worn by a user, which includes: a fan housing having a base portion, the base portion of the fan housing having a bottom surface with at least one attachment member disposed thereon; a power source disposed in the base portion of the fan housing; a plurality of fan blades pivotally disposed about a rotational axis; a motor for driving the fan blades during an operational state of the fan assembly, the motor being operatively coupled to the power source in the base portion of the fan housing; and a detachable component configured to matingly engage with the at least one attachment member disposed on the bottom surface of the base portion of the fan housing. In this embodiment, when the fan assembly is attached to an article of clothing worn by a user, a portion of the article of clothing is sandwiched between a bottom surface of the at least one attachment member and a top surface of the detachable component.

In accordance with a fourth aspect of the present invention, there is provided a wearable fan assembly configured to be attached to an article of clothing worn by a user, which includes: a fan housing having a base portion, the base portion of the fan housing having a bottom surface with at least one aperture disposed therein; a power source disposed in the base portion of the fan housing; a plurality of fan blades pivotally disposed about a rotational axis; a motor for driving the fan blades during an operational state of the fan assembly, the motor being operatively coupled to the power source in the base portion of the fan housing; and a detachable component having a top surface with at least one pointed protrusion extending therefrom, the at least one pointed protrusion configured to matingly engage with the at least one aperture disposed in the bottom surface of the base portion of the fan housing. In this embodiment, when the fan assembly is attached to an article of clothing worn by a user, a portion of the article of clothing is sandwiched between the bottom surface of the base portion of the fan housing and a top surface of the detachable component.

In accordance with a fifth aspect of the present invention, there is provided a method for convectively cooling a user that utilizes a wearable fan assembly, the method comprising the steps of: (i) providing a wearable fan assembly configured to be attached to an article of clothing worn by a user, the wearable fan assembly including: a fan housing having a base portion, the base portion of the fan housing having a bottom surface with at least one magnet disposed thereon; a power source disposed in the base portion of the fan housing; a plurality of fan blades pivotally disposed about a rotational axis; a motor for driving the fan blades during an operational state of the fan assembly, the motor being operatively coupled to the power source in the base portion of the fan housing; a power switch for selectively regulating the flow of current from the power source to the motor, the power switch disposed on the base portion of the fan housing; and a detachable component configured to matingly engage with the at least one magnet disposed on the bottom surface of the base portion of the fan housing; (ii) positioning the detachable component of the wearable fan assembly on a limb of the user and underneath the article of clothing worn by the user; (iii) positioning the at least one magnet disposed on the bottom surface of the base portion of the fan housing in close proximity to the detachable component such that the at least one magnet matingly engages with the detachable component, thereby sandwiching a portion of the article of clothing worn by the user between a bottom surface of the at least one magnet and a top surface of the detachable component; and (iv) activating the wearable fan assembly by moving the power switch disposed on the base portion of the fan housing to its “on” position, thereby generating airflow for convectively cooling the user.

It is to be understood that the foregoing summary and the following detailed description of the present invention are merely exemplary and explanatory in nature. As such, the foregoing summary and the following detailed description of the invention should not be construed to limit the scope of the appended claims in any sense.

### BRIEF DESCRIPTION OF THE SEVERAL VIEWS OF THE DRAWINGS

The invention will now be described, by way of example, with reference to the accompanying drawings, in which:

FIG. 1 is a frontal perspective view of a fan portion of the wearable fan assembly according to an embodiment of the invention;

FIG. 2 is a rear perspective view of the fan portion of the wearable fan assembly according to an embodiment of the invention;

FIG. 3 is a side view of the fan portion of the wearable fan assembly according to an embodiment of the invention;

FIG. 4 is a bottom perspective view of the fan portion of the wearable fan assembly according to an embodiment of the invention;

FIG. 5 is a frontal perspective view of a detachable component of the wearable fan assembly according to one embodiment of the invention;

FIG. 6 is a rear perspective view of the detachable component of the wearable fan assembly according to one embodiment of the invention;

FIG. 7 is a frontal perspective view of a detachable component of the wearable fan assembly according to another embodiment of the invention;

FIG. 8 is a rear perspective view of a detachable component of the wearable fan assembly according to another embodiment of the invention;

FIG. 9 is a side view of the fan portion of the wearable fan assembly in a collapsed state according to an embodiment of the invention;

FIG. 10 is a partial rear perspective view of the fan portion of the wearable fan assembly according to an embodiment of the invention, wherein the power source of the fan is depicted;

FIG. 11 is a perspective view illustrating the insertion of the detachable component underneath the clothing of a user according to an embodiment of the invention;

FIG. 12 is a perspective view illustrating the location of the detachable component on the leg of a user according to an embodiment of the invention;

FIG. 13 is a rear perspective view of the fan portion of the wearable fan assembly attached to the clothing of a user according to an embodiment of the invention, wherein the wearable fan assembly is depicted in its operational position;

FIG. 14 is a frontal perspective view of the fan portion of the wearable fan assembly attached to the clothing of a user according to an embodiment of the invention, wherein the wearable fan assembly is depicted in its operational position;

FIG. 15 is a frontal perspective view of the fan portion of the wearable fan assembly attached to the clothing of a user according to an embodiment of the invention, wherein the wearable fan assembly is depicted in its collapsed state;

FIG. 16 is a side perspective view of the wearable fan assembly attached to a piece of fabric according to an embodiment of the invention;

FIG. 17 is a partial longitudinal sectional view of the detachable component of the wearable fan assembly according to an embodiment of the invention, which is cut along the cutting-plane line A-A in FIG. 5;

FIG. 18 is a partial transverse sectional view of the wearable fan assembly attached to a piece of fabric according to an embodiment of the invention, which is cut along the cutting-plane line B in FIG.16;

FIG. 19 is a partial transverse sectional view of the wearable fan assembly prior to being attached to a piece of fabric according to an embodiment of the invention, which is otherwise similar in nature to the view depicted in FIG.18;

FIG. 20 is a partial transverse sectional view of the detachable component of the wearable fan assembly according to an alternative embodiment of the invention;

FIG. 21 is a partial transverse sectional view of the detachable component of the wearable fan assembly according to another alternative embodiment of the invention; and

FIG. 22 is a partial transverse sectional view of the detachable component of the wearable fan assembly according to yet another alternative embodiment of the invention.

Throughout the figures, the same parts are always denoted using the same reference characters so that, as a general rule, they will only be described once.

### DETAILED DESCRIPTION OF THE PREFERRED EMBODIMENT(S) OF THE INVENTION

An embodiment of the wearable fan assembly is seen generally at 10 in FIG. 16. The wearable fan assembly 10 of the depicted embodiment principally comprises a fan portion 12 and a detachable component 14. As shown in FIG. 16, and more explicitly in the sectional view of FIG. 18, the fan portion 12 engages the detachable component 14 in such a manner that a piece of fabric 16 (preferably a portion of the clothing on a user) is sandwiched between the fan portion 12 and the detachable component 14. In a preferred embodiment of the invention, the wearable fan assembly 10 is configured to be attached to an article of clothing worn by a user thereof.

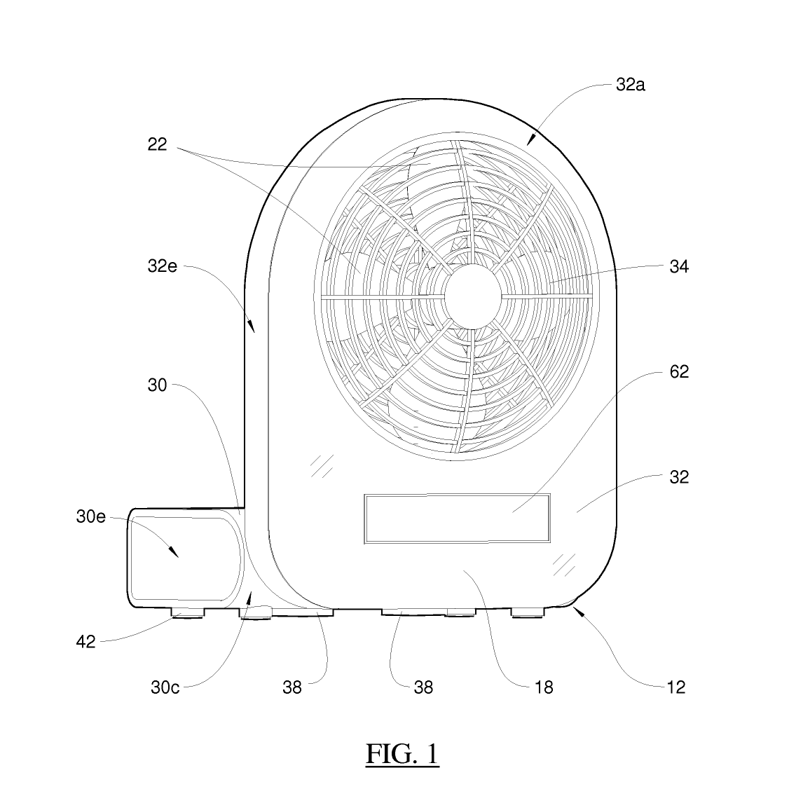

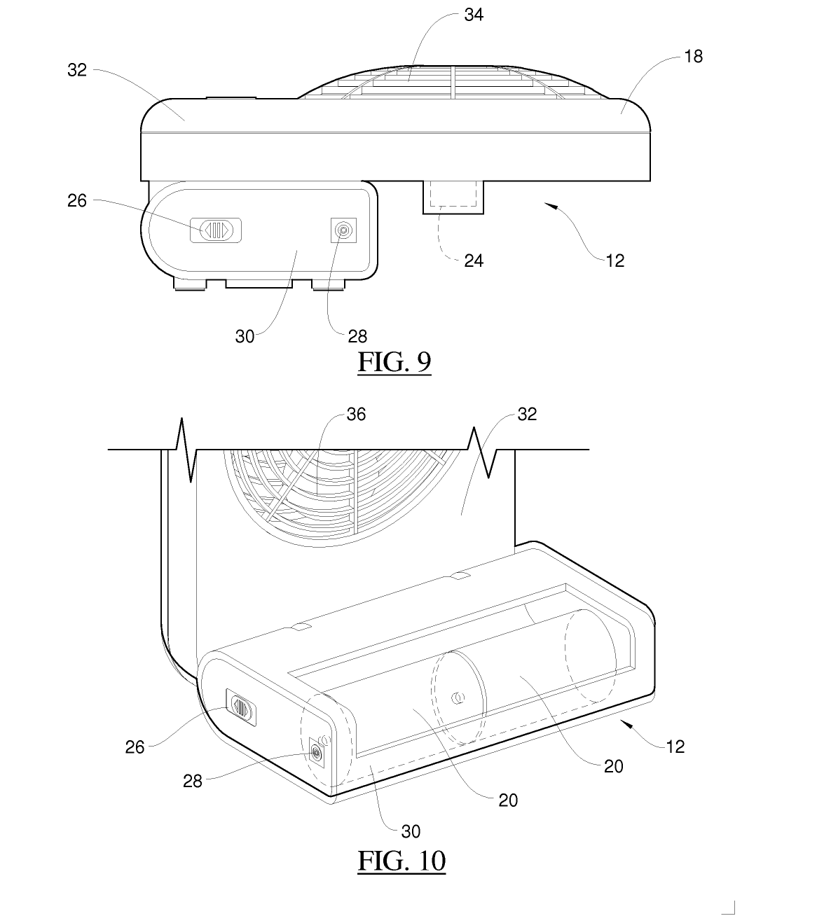

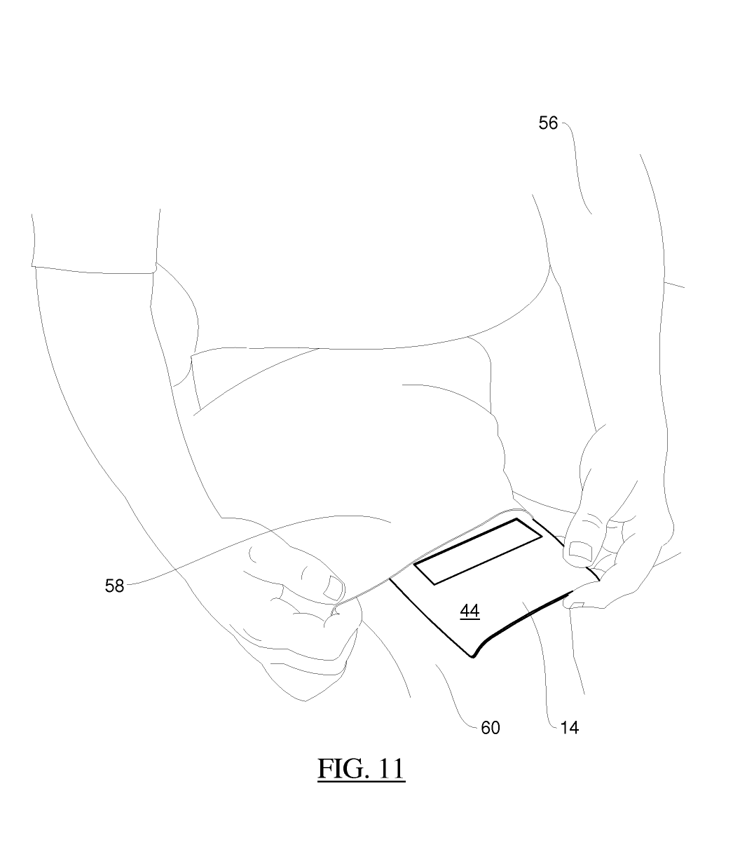

Referring to FIGS. 1-4 and 9-10, it can be seen that the fan portion 12 (also referred to herein as fan 12) of the wearable fan assembly 10 generally comprises a fan housing 18, a power source 20, a plurality of fan blades 22 disposed about a rotational axis RA1, and a direct current (DC) electric motor 24 for driving the plurality of fan blades 22 during the operational state of the fan assembly 10. The electric motor 24 is operatively coupled to the power source 20 (see FIG. 10) by means of electrical wiring (not shown). When a power switch 26 (see FIG. 9) is moved to its “on” position by a user of the fan assembly 10, electrical current flows from the power source 20 to the electrical motor 24 which, in turn, rotates the plurality of fan blades 22.

In a preferred embodiment of the invention, the power source 20 depicted in FIG. 10 comprises two (2) type D batteries, each having an output voltage of approximately 1.50 volts direct current (VDC). However, the fan 12 is preferably configured to utilize an alternative source of power as well. In particular, as shown in FIG. 9, a side of the fan housing 18 is provided with a power receptacle 28 disposed therein for receiving a plug of an alternating current-to-direct current (AC-to-DC) power adapter. Preferably, the AC-to-DC power adapter has an output voltage of approximately 3.0 volts direct current (VDC) and an output current of approximately 500 milliamperes (mA). By utilizing the AC-to-DC power adapter, the fan 12 can be advantageously powered by means of the standard electrical system in a building or dwelling. Thus, when operating the fan 12 inside a building, a user of the fan 12 can utilize an AC power source for driving the fan blades 22, thereby extending the usable life of the batteries.

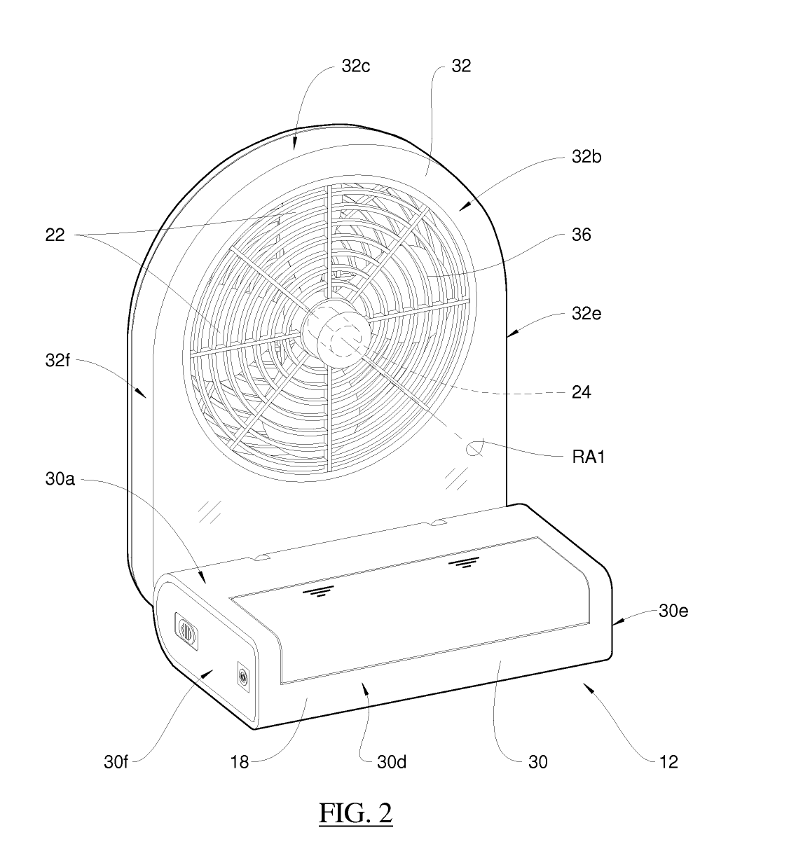

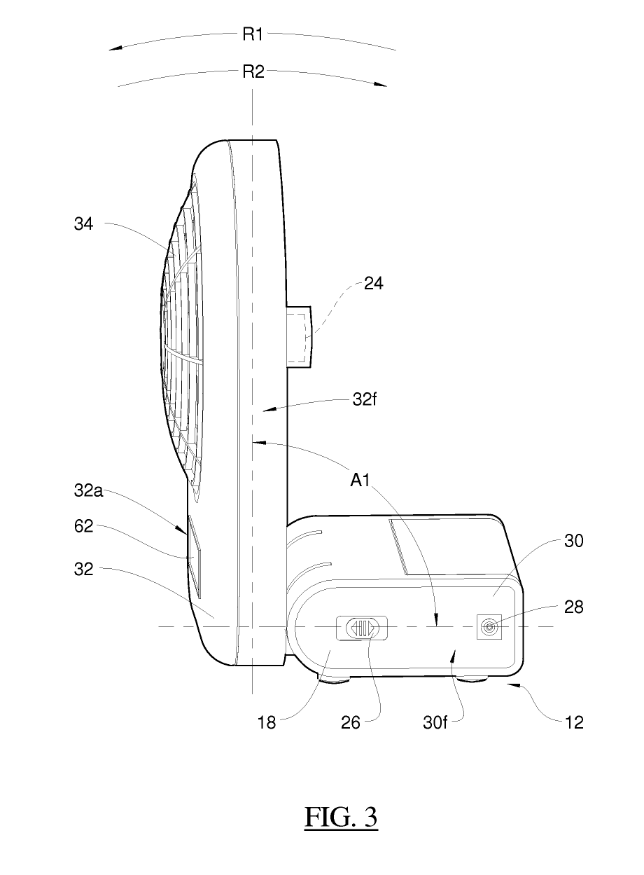

As best shown in FIGS. 1-4, the fan housing 18 of the fan 12 comprises a first fan housing portion 30 and a second fan housing portion 32 rotatably connected to the first fan housing portion 30. As illustrated in these figures, the first fan housing portion 30 forms the base of the fan 12, and includes a top surface 30a, a bottom surface 30b disposed opposite to the top surface 30a, and a plurality of side surfaces 30c-30f extending between the bottom surface 30b and the top surface 30a. The front-side surface 30c is disposed opposite to the rear-side surface 30d, whereas the left-side surface 30e is disposed opposite to the right-side surface 30f. As most clearly shown in FIG. 3, the right-side surface 30f of the first fan housing portion 30 contains the power switch 26 and the power receptacle 28 for receiving the plug of the AC-to-DC power adapter. Referring collectively to FIGS. 1-4, it can be seen that the second fan housing portion 32 encloses the plurality of fan blades 22 and the electric motor 24, and includes a curved front surface 32a, a rear surface 32b disposed opposite to the front surface 32a, and a plurality of side surfaces 32c-32f circumscribing the front surface 32a and the rear surface 32b. The curved top-side surface 32c is disposed generally opposite to the bottom-side surface 32d, whereas the left-side surface 32e is disposed generally opposite to the right-side surface 32f. As best shown in FIGS. 1 and 2, the fan 12 is advantageously provided with both a front fan guard 34 and a rear fan guard 36 so as to protect a user from the rotating fan blades 22. For example, the fan guards 34, 36 prevent the fingers of a user from coming into contact with the rotating fan blades 22, thereby preventing injury thereto. As shown in FIGS. 1 and 3, the front surface 32a of the fan 12 is preferably provided with a space for indicia 62 located beneath front fan guard 34. In some embodiments, the indicia may constitute a logo and/or brand name associated with the manufacturer of the wearable fan assembly 10 (i.e., the manufacturer's trademark). While in other embodiments, the indicia could take the form of a collegiate or professional sports team logo (e.g., a logo of the user's favorite baseball or football team).

In a preferred embodiment of the invention, the second fan housing portion 32 is rotatably connected to the first fan housing portion 30 so that a user is able to selectively pivot the second fan housing portion 32 relative to the first fan housing portion 30 as indicated by the curved arrows R1, R2 in FIG. 3. This pivotal mounting arrangement of the second fan housing portion 32 with respect to the first fan housing portion 30 is advantageous for several reasons. First, it allows a user to adjust the airflow direction of the fan 12 so as to enable the user to direct the airflow towards the portion of his or her body that requires cooling (e.g., towards the torso of the user). Secondly, the pivotal mounting arrangement of the second fan housing portion 32 with respect to the first fan housing portion 30 allows the fan 12 to be collapsed when it is not being used (see e.g., FIG. 9) so as to reduce its overall size, thereby enhancing its portability.

Now, referring to FIG. 4, the attachment means provided on the bottom surface 30b of the first fan housing portion 30 will be described in detail. As illustrated in this figure, a preferred embodiment of the invention includes attachment means in the form of two magnets 38 disposed on the bottom surface 30b of the first fan housing portion 30. These magnets 38 are configured to matingly engage with at least a portion of the detachable component 14. In FIG. 4, it can be seen that each magnet 38 is fixedly attached to the bottom surface 30b of the first fan housing portion 30 by means of a respective screw 40. However, it is to be understood that each magnet 38 may be affixed to the bottom surface 30b using other suitable attachment means as well. For example, each magnet 38 may be alternatively affixed to the bottom surface 30b of the first fan housing portion 30 by using an adhesive, a rivet, or a sufficiently strong snap-fit joining mechanism.

In one embodiment of the invention, each magnet 38 is approximately seventh-eighths (⅞) of an inch in diameter (i.e., outside diameter). Although, one of ordinary skill in the art will appreciate that, in other embodiments of the invention, each magnet 38 may have a different outside diameter. For example, the inventor has additionally contemplated using magnets with outside diameters of approximately one (1) inch, three-quarters (¾) of an inch, five-eighths (⅝) of an inch, and one-half (½) of an inch. Also, in other exemplary embodiments of the invention, the magnets 38 have a different geometric shape. For example, the magnets 38 could be rectangular or square-shaped, rather than circular.

In an exemplary embodiment of the invention, a magnet 38 with an outside diameter of three-quarters (¾) of an inch has the following specifications: (1) a thickness of approximately one-eighth (⅛) of an inch; (2) a countersunk aperture extending centrally therethrough for receiving a #8 screw; (3) material composition: neodymium (NdFeB), Grade N42; (4) plating/coating: Ni—Cu—Ni (Nickel); (5) axially magnetized with poles on the flat ends; (6) approximate weight: 0.424 oz. (12.02 g), per pair; (7) a pull force ranging from approximately 8.68 lbs. to approximately 29.25 lbs. depending upon the particular mounting arrangement; (8) a residual flux density (Brmax) of approximately 13,200 Gauss; and (9) a maximum energy product (BHmax) of 42 Mega Gauss Oersteds (MGOe).

In another exemplary embodiment of the invention, a magnet 38 with an outside diameter of five-eighths (⅝) of an inch has the following specifications: (1) a thickness of approximately one-eighth (⅛) of an inch; (2) a countersunk aperture extending centrally therethrough for receiving a #6 screw; (3) material composition: neodymium (NdFeB), Grade N42; (4) plating/coating: Ni—Cu—Ni (Nickel); (5) axially magnetized with poles on the flat ends; (6) approximate weight: 0.296 oz. (8.36 g), per pair; (7) a pull force ranging from approximately 7.15 lbs. to approximately 20.12 lbs. depending upon the particular mounting arrangement; (8) a residual flux density (Brmax) of approximately 13,200 Gauss; and (9) a maximum energy product (BHmax) of 42 Mega Gauss Oersteds (MGOe).

In yet another exemplary embodiment of the invention, a magnet 38 with an outside diameter of one-half (½) of an inch has the following specifications: (1) a thickness of approximately one-eighth (⅛) of an inch; (2) a countersunk aperture extending centrally therethrough for receiving a #4 screw; (3) material composition: neodymium (NdFeB), Grade N42; (4) plating/coating: Ni—Cu—Ni (Nickel); (5) axially magnetized with poles on the flat ends; (6) approximate weight: 0.197 oz. (5.58 g), per pair; (7) a pull force ranging from approximately 5.35 lbs. to approximately 12.30 lbs. depending upon the particular mounting arrangement; (8) a residual flux density (Brmax) of approximately 13,200 Gauss; and (9) a maximum energy product (BHmax) of 42 Mega Gauss Oersteds (MGOe).

The use of magnets 38 as a means of attachment between the fan portion 12 and the detachable component 14 offers numerous advantages. First, the magnets 38 provide a connection between the fan portion 12 and the detachable component 14 that is sufficiently strong so that a user does not have to be concerned with the fan portion 12 becoming inadvertently detached from the detachable component 14. Secondly, the magnets 38 do not contain any sharp edges, and thus, do not pose a safety risk to the user of the wearable fan assembly 10. Finally, the magnets 38 enable the fan portion 12 to be easily attached to, and detached from, the detachable component 14, thereby facilitating its utilization by a user thereof.

Referring again to FIG. 4, it can be seen that the bottom surface 30b of the first fan housing portion 30 is also provided with a plurality of mounting pads or feet 42 disposed thereon, each mounting pad 42 being disposed near a respective corner of the bottom surface 30b. In a preferred embodiment, the mounting pads 42 are self-adhesive type mounting pads that can be affixed to the bottom surface 30b of the first fan housing portion 30 without the use of an additional adhesive or fastener. Also, each mounting pad 42 preferably has a thickness that is slightly greater than the thickness of each magnet 38 (e.g., slightly greater than one-eighth (⅛) of an inch) so that the fan 12 can stably rest on the top surface of furniture (e.g., a table or a desk) using the plurality of mounting pads 42. As a result, the fan 12 is capable of being used in other applications, which do not require the use of the detachable component 14.

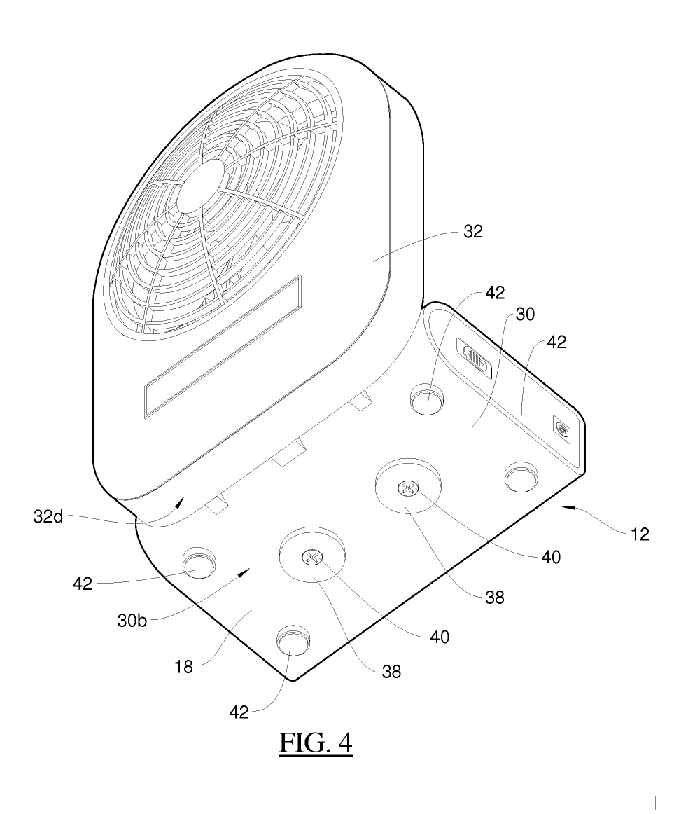

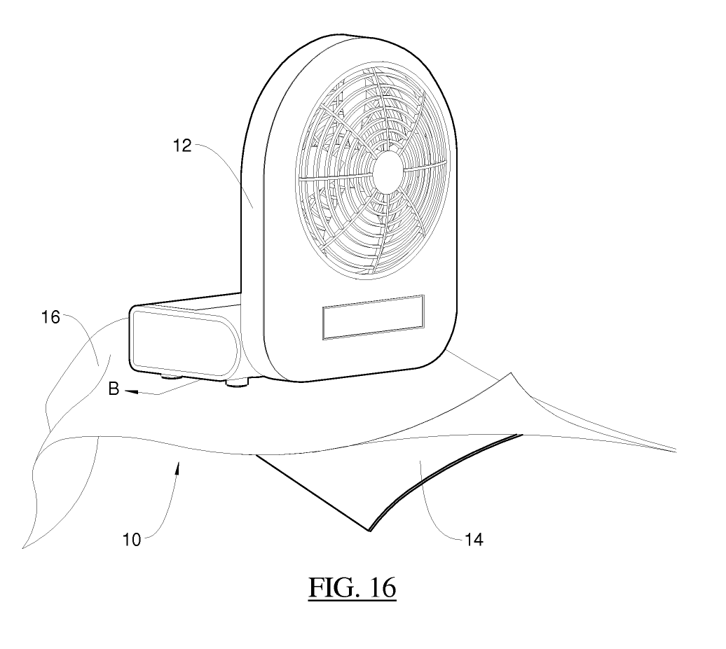

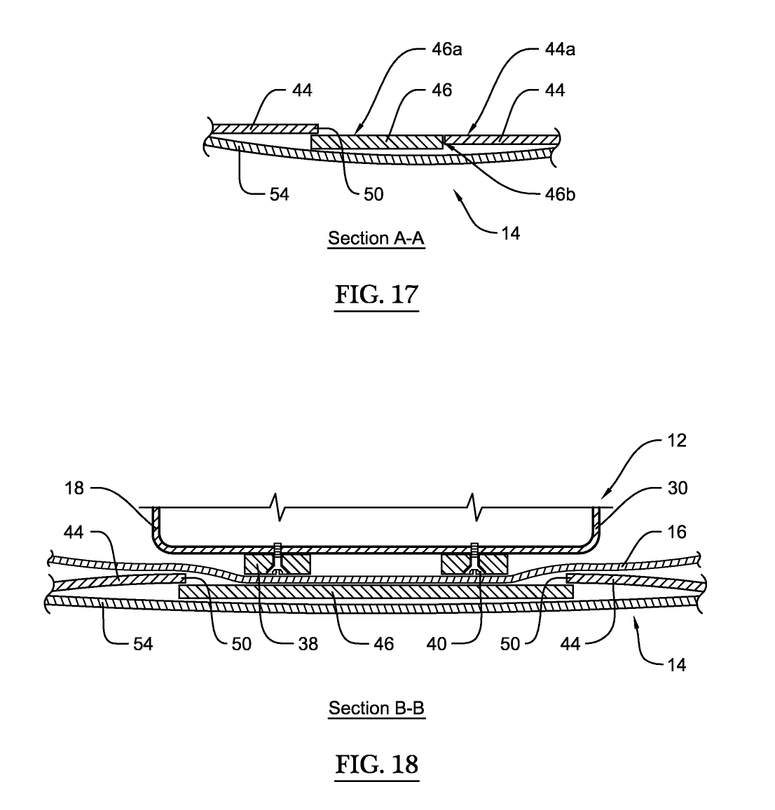

Now, with reference to FIGS. 5, 6, and 17, one embodiment of the detachable component 14 will be described in detail. As illustrated in the first preferred embodiment of FIG. 5, the detachable component 14 comprises a curved plate portion 44 and a metallic plate portion 46 (e.g., a metal plate) that is centrally disposed on the curved plate portion 44. In the illustrated embodiment, the curved plate portion 44 is provided with an aperture 48 disposed through a central region thereof. The metallic plate portion 46 is disposed adjacent to the bottom surface of the curved plate portion 44 and is positioned behind the aperture 48 in the curved plate portion 44. Preferably, the aperture 48 is smaller in size as compared to the metallic plate portion 46 such that the curved plate portion 44 overlaps the metallic plate portion 46 on a plurality of its sides, thereby forming a lip 50. Although, in the illustrated embodiment, the top surface 44a of the curved plate portion 44 is substantially flush with the top surface 46a of the metallic plate portion 46 along at least one outer edge 46b of the metallic plate portion 46 so that the detachable component 14 and the fan portion 12 are capable of being easily detached from one another (refer to FIG. 17).

In one preferred embodiment, the curved plate portion 44 has a curvature that approximately matches the outer curvature of a limb of an average user (e.g., the curved plate portion 44 has a curvature that approximates the curvature of a thigh having a circumference of between 20 and 24 inches). In another preferred embodiment, the curved plate portion 44 can be formed from a flexible polymeric material, such as a bendable plastic or rubber, that is capable of being elastically deformed in a convex shape that approximates the outer curvature of a limb of a user.

In one embodiment, the middle portion of the curved plate portion 44 is substantially flat, while the lateral edge portions of the curved plate portion 44 are curved. In another embodiment, the curved plate portion 44 is continually curved across the entire width thereof. In this embodiment, the curved plate portion 44 has a cross-section with an inverted parabolic shape, wherein the magnitude of the slope of the inverted parabola gradually increases from the inner vertex to its outer boundary points.

As shown in illustrated embodiment of FIG. 5, the top surface 44a of the curved plate portion 44 is provided with indicia 52 thereon for indicating the preferred direction in which the detachable component 14 is to be inserted underneath an article of clothing worn by a user. In FIG. 5, the indicia 52 is in the form of an arrow imprinted on the top surface 44a of the curved plate portion 44. The indicia 52 could also be inscribed on the top surface 44a of the curved plate portion 44 using permanent ink. Although, those of ordinary skill in the art will appreciate that other suitable indicia 52 may also be used without departing from the spirit and scope of the claimed invention. In a preferred embodiment, the curved plate portion 44 is provided with slight inward taper along its length in a direction opposite to the pointing direction of the indicia 52.

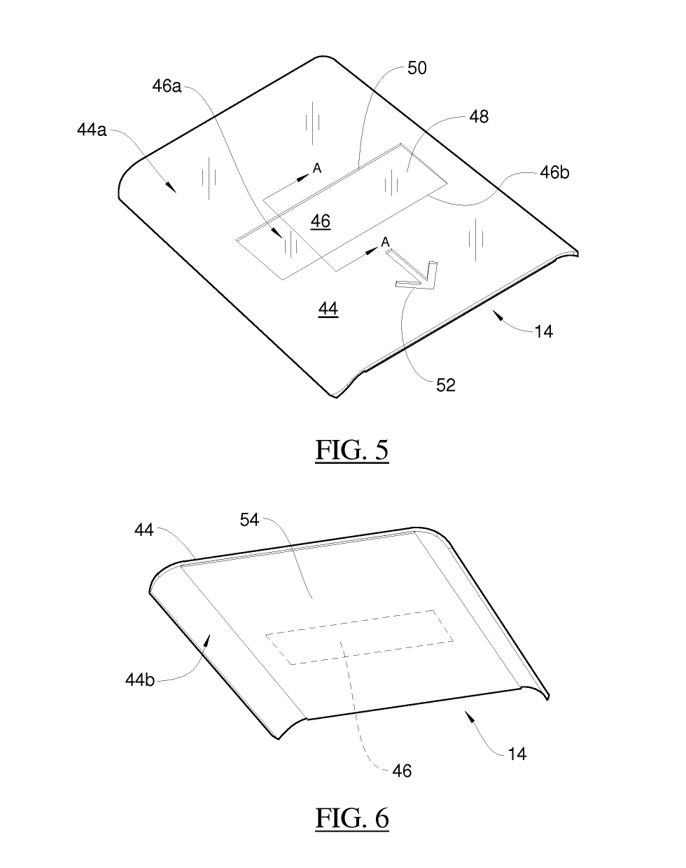

As best shown in FIG. 6, the detachable component 14 preferably includes a backing material 54 disposed on the bottom surface 44b of the curved plate portion 44. As depicted in this figure, the backing material 54 substantially covers the surface bottom 44b of the curved plate portion 44 and the entire bottom surface of the metallic plate portion 46. Preferably, the backing material 54 is fixedly attached to the bottom surface 44b of the curved plate portion 44 by virtue of a suitable adhesive or glue. Alternatively, the backing material 54 could be provided with a self-adhesive strip(s) disposed thereon so as to obviate the need for a separate attachment means. When the detachable component 14 is slid under an article of clothing worn by a user, the backing material 54 lies adjacent to the skin of the user, and thus, it is preferred the backing material 54 be constructed of a suitably soft material. For example, the backing material 54 could be formed from a felt material, a foam material, or a sponge material. Advantageously, the backing material 54 prevents the rough surfaces of the curved plate portion 44 and the metallic plate portion 46 from resting against the skin of a user when the detachable component 14 is placed underneath his or her article of clothing.

In a preferred embodiment, the detachable component 14 has an overall length of approximately five and three-quarter (5¾) inches, a width of approximately four and one-half (4½) inches at its narrowest end, a width of approximately five (5) inches at its widest end, and a height of approximately three-eighths (⅜) of an inch as measured from one of its bottom lateral edges to its apex of curvature. Also, in a preferred embodiment, the metallic plate portion 46 has a length of approximately three and one-half (3½) inches and a width of approximately one and one-quarter (1¼) inches. Although, it is to be understood that the invention is not limited to these particular dimensions. Rather, the invention may be practiced using other suitable dimensions without departing from the spirit and scope of the appended claims.

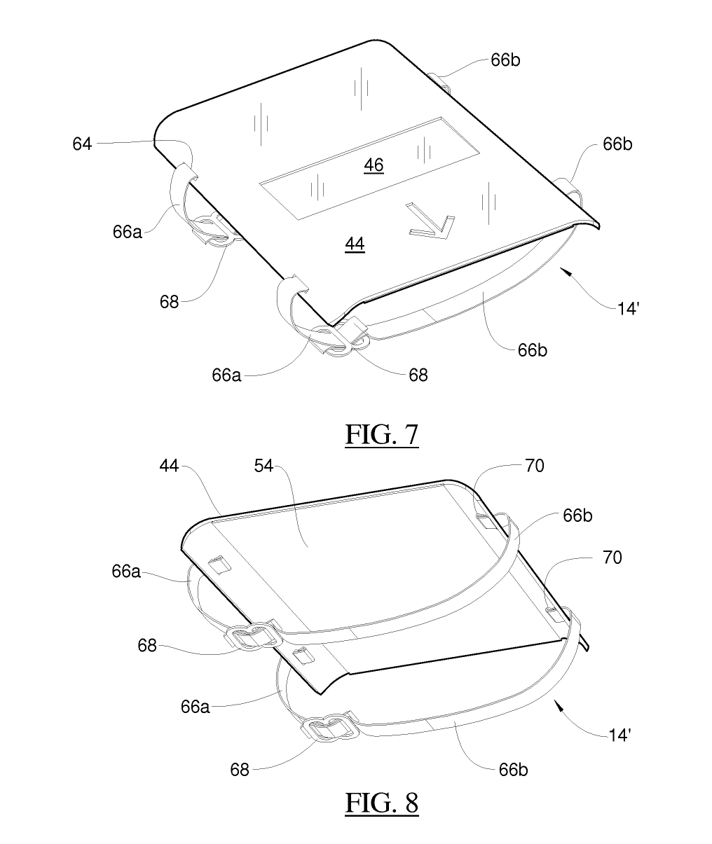

Referring now to FIGS. 7 and 8, another embodiment of the detachable component will be described. The detachable component 14′ illustrated in FIGS. 7 and 8 is similar in most respects to the detachable component 14 explained above. However, unlike the detachable component 14, the detachable component 14′ is provided with a plurality of strap members 66a, 66b attached thereto. The inclusion of the strap members 66a, 66b on the detachable component 14′ enables the detachable component 14′ to be more easily utilized by a user wearing long pants or jeans. In such a situation, it would be quite challenging for a user to hold the detachable component 14 of FIGS. 5 and 6 in place underneath his or her long pants or jeans.

As shown in FIGS. 7 and 8, the curved plate portion 44 of the detachable component 14′ is provided with a plurality of apertures 64 in the curved sides thereof. Each aperture 64 accommodates a respective strap member 66a, 66b passing therethrough. As best illustrated in FIG. 8, each strap member 66a, 66b is provided with a crimped end 70 in order to retain the strap member 66a, 66b in its respective aperture 64. It can be seen that the free end (i.e., the end opposite to the crimped end 70) of each strap member 66a is joined to a respective free end of each strap member 66b at a buckle 68. In particular, the free ends of respective strap members 66a, 66b are threaded through each buckle 68. Advantageously, the use of the buckle 68 to join the strap members 66a, 66b allows the length of the strap members to be adjusted around the limb of a user so that the detachable component 14′ can be held securely in place.

In one preferred embodiment, the strap members 66a, 66b and the buckle 68 are formed using a polymeric material, such as a plastic or rubber. While the buckle 68 could be formed using a hard plastic material, it is preferred that the strap members 66a, 66b are formed using a readily flexible plastic or rubber that is easy to bend around the limb of a user. In other embodiments of the invention, the strap members 66a, 66b could be formed using a woven strap material (e.g., a woven nylon strap) or other suitable flexible material, rather than a pliable plastic or rubber.

While two straps are depicted in the illustrated embodiment of FIGS. 7 and 8, each being a formed from paired strap members 66a, 66b, it is to be understood that the invention is not so limited. Rather, in other embodiments of the detachable component, more than two straps could be utilized. Also, while not particularly preferred, only a single strap could be used.

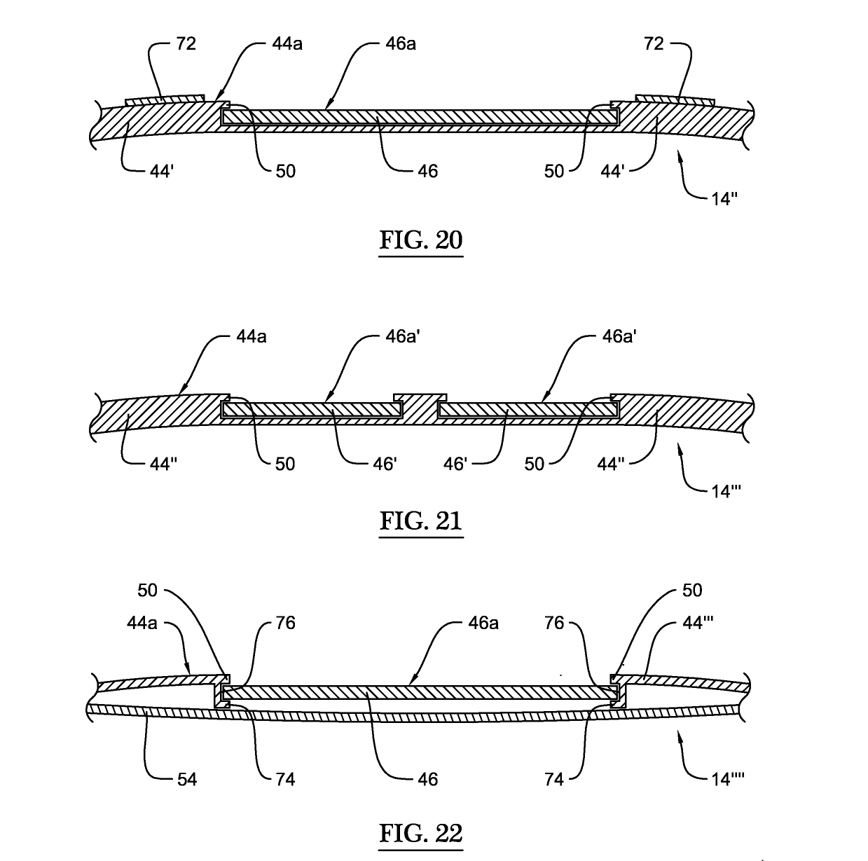

With reference to FIGS. 20, 21, and 22, three other alternative embodiments of the detachable component will be explained. First, as shown in FIG. 20, the metallic plate portion 46 of the alternative detachable component 14″ is embedded in the curved plate portion 44′. Unlike the previously described embodiments of the detachable component 14, 14′, the curved plate portion 44′ of the detachable component 14″ extends behind the metallic plate portion 46, thereby enabling the rear surface of the detachable component 14″ to have a generally smooth contour. Because the rear surface of the detachable component 14″ does not have the rough edges that are present in the detachable components 14, 14′ (e.g., resulting from the exposed rear edges of the metallic plate portion 46), it is possible to omit the backing material 54 in this embodiment of the detachable component (14″) if desired. However, even in this embodiment, it could still be advantageous to include the backing material 54 on the detachable component 14″ to minimize the potential for slippage on a user's leg or to enhance the comfort of the user.

As also shown in FIG. 20, the curved plate portion 44′ can be provided with several spaced-apart pieces 72 of double-stick tape or hook-and-loop fasteners disposed on the top surface 44a thereof. Advantageously, these pieces 72 of double-stick tape or hook-and-loop fasteners will enable the curved plate portion 44′ to be removably affixed to the bottom surface of an article of clothing worn by a user, thereby preventing the detachable component 14″ from becoming unintentionally disengaged from the article of clothing when fan portion 12 is not matingly engaged therewith.

Another alternative embodiment of the detachable component is illustrated in FIG. 21. The detachable component 14′″ depicted in FIG. 21 is similar in most respects to the detachable component 14″ of FIG. 20. However, rather than using a single generally rectangular metallic plate portion 46, the detachable component 14′″ utilizes two approximately square metallic plate portions 46′ with top surfaces 46a′. In this embodiment of the detachable component (14″), each magnet 38 on the bottom surface 30b of first fan housing portion 30 magnetically engages a respective metallic plate portion 46′. As shown in FIG. 21, the metallic plate portions 46′ are preferably embedded into the curved plate portion 44″. In one preferred embodiment, the curved plate portion 44″ is formed from a molded plastic material, and the metallic plate portions 46′ are molded into the curved plate portion 44″ when it is being formed.

Yet another alternative embodiment of the detachable component is presented in FIG. 22. Referring to this figure, it can be seen that the bottom surface of the curved plate portion 44′″ of the detachable component 14″″ is provided with opposed protrusions 74 for holding the metallic plate portion 46 in place. Each protrusion 74 has an L-shaped cross-section and extends substantially the width of the metallic plate portion 46. As shown in FIG. 22, the L-shaped geometry of each protrusion 74 defines an elongated slot 76 for receiving an edge of the metallic plate portion 46. Advantageously, the protrusions 74 with slots 76 facilitate the attachment of the metallic plate portion 46 to the curved plate portion 44′. In this embodiment, the metallic plate portion 46 is bounded on three of its four sides by the opposed protrusions 74, and the side of the aperture 48 in the curved plate portion 44′″ that abuts the outer edge 46b of the metallic plate portion 46 (see FIG. 17). In one preferred embodiment, the metallic plate portion 46 is secured to the adjoining surfaces of the curved plate portion 44′″ (e.g., interior surfaces of slots 76) using a suitable adhesive or glue.

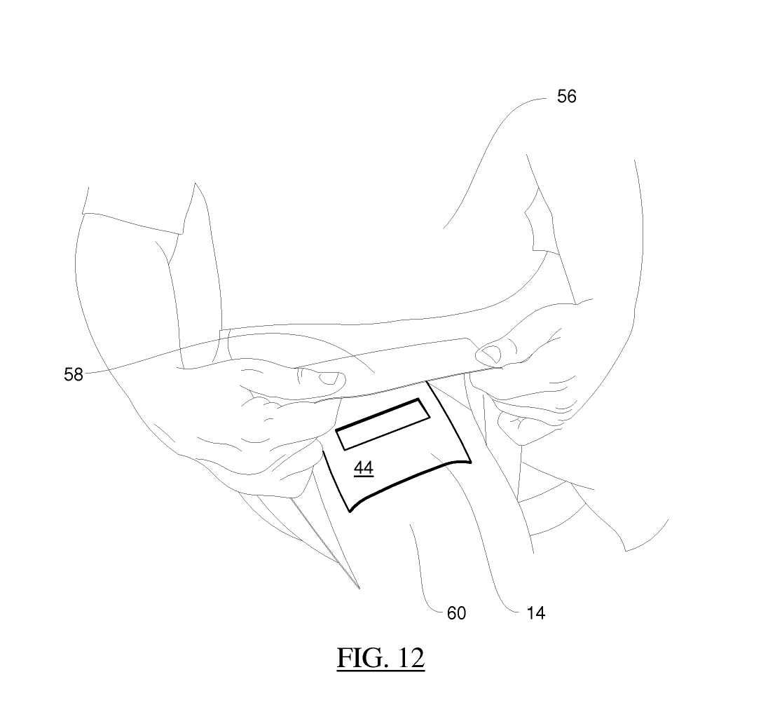

Now, referring to FIGS. 11-15, the functionality of the wearable fan assembly 10 will be described in detail. Initially, as shown in FIG. 11, a user 56 slides the detachable component 14 underneath his or her article of clothing 58. Preferably, when positioning the detachable component 14 under his or her clothing 58, the user 56 slides the detachable component 14 in the direction indicated by the indicia 52 on the top surface 44a of the curved plate portion 44 (e.g., directional arrow in FIG. 5). In the illustrated embodiment of FIG. 11, it can be seen that the detachable component 14 is being positioned on the leg 60 of a user 56. As explained above, the curved plate portion 44 preferably has a curvature that approximately matches the outer curvature of a limb of a user. In the illustrated embodiment, the curvature of the curved plate portion 44 would substantially match the outer curvature of the user's leg 60. In FIG. 12, the user 56 is lifting up his article of clothing 58 (i.e., his shorts) so that the manner in which the detachable component 14 rests on the top surface of his leg 60 can be better visualized.

The alternative detachable component 14′, which includes strap members 66a, 66b, is positioned in a different manner underneath an article of clothing worn by a user. For example, if the user wishes to position the detachable component 14′ on his or her leg, it is easiest for the user to attach the detachable component 14′ to his or leg prior to putting on his or her long pants or jeans. In accordance with one such method for attaching the detachable component 14′, the user first loosens the strap members 66a, 66b and then places his or her foot into the straps of the detachable component 14′. After which, the user slides the detachable component 14′ up his or her leg until the detachable component 14′ reaches the desired position (e.g., adjacent to the thigh of the user). Then, the user utilizes the buckles 68 on the detachable component 14′ to tighten the paired strap members 66a, 66b and secure the detachable component 14′ in place. Finally, the user pulls his or her long pants or jeans on over the detachable component 14′ such that the detachable component 14′ is covered thereby. Alternatively, rather than sliding the detachable component 14′ up his or her leg, a user can completely disengage the strap members 66a, 66b from their respective buckles 68 and then, subsequently reattach the strap members 66a, 66b to their respective buckles 68 once the detachable component 14′ is appropriately positioned on the user's leg. This alternative method for attaching the detachable component 14′ to the user's leg could be utilized when a user wishes to position the detachable component 14′ on his or her leg without completely removing his or her long pants or jeans (i.e., when the detachable component 14′ is attached to a user's leg after the user has already put on his or her pants or jeans).

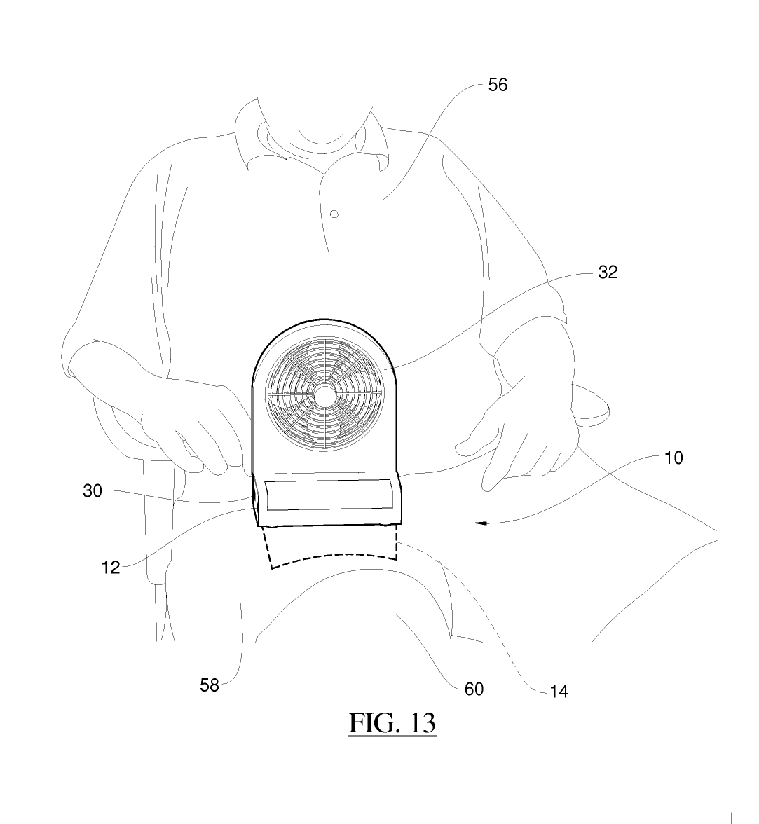

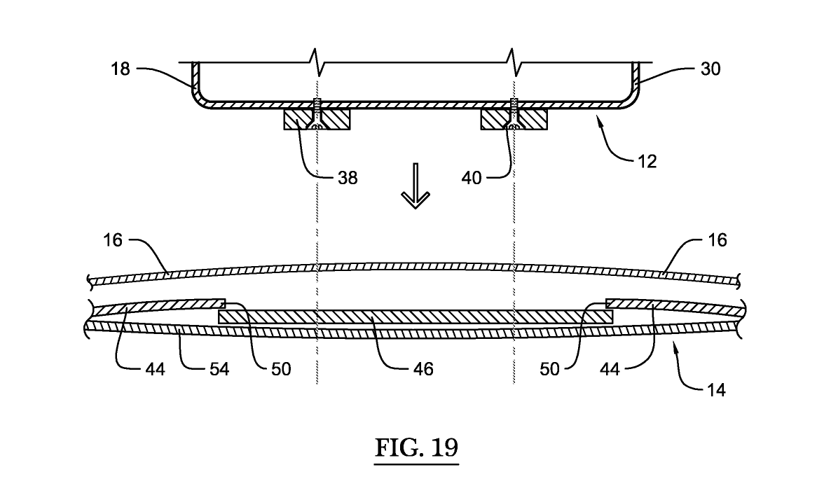

After the detachable component 14 is appropriately positioned underneath the article of clothing 58 worn by the user 56, the user then attaches the fan portion 12 of the wearable fan assembly 10 to the detachable component 14. Specifically, the user 56 generally aligns the magnets 38 that are fixedly attached to the bottom surface 30b of first fan housing portion 30 (see FIGS. 4 and 19) with the metallic plate portion 46 of the detachable component 14 (see FIGS. 5 and 19) so that the magnets 38 matingly engage with the metallic plate portion 46. Once the fan portion 12 and the detachable component 14 are securely attached to one another (see e.g., FIGS. 13, 16, and 18), a portion of the article of clothing 58 worn by the user 56 (i.e., piece of fabric 16) becomes sandwiched between the bottom surfaces of the magnets 38 and a top surface of the detachable component 14 (i.e., a top surface of the metallic plate portion 46).

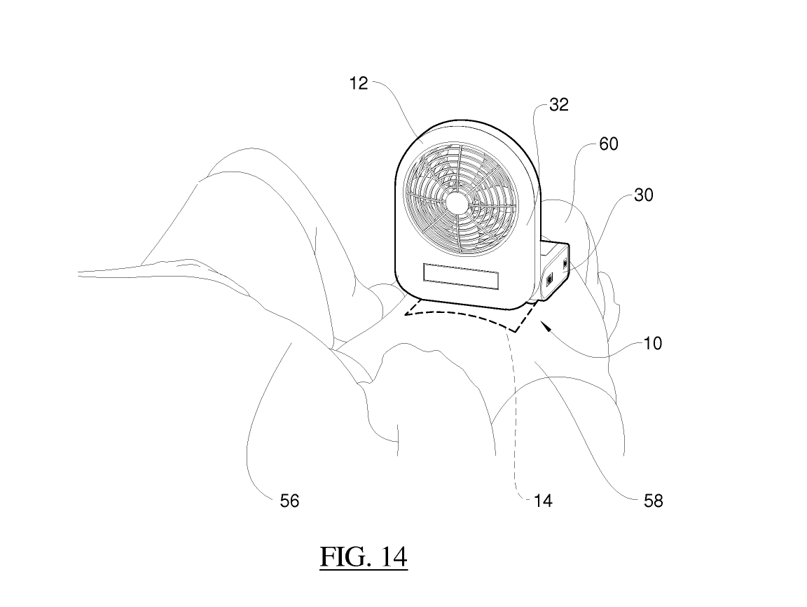

In FIGS. 13 and 14, the wearable fan assembly 10 is depicted in its operational position. As illustrated in these figures, the detachable component 14 is concealed under the article of clothing 58 worn by the user 56, and thus, is shown using hidden lines. Prior to operating the fan 12, a user 56 will typically rotate the second fan housing portion 32 relative to the first fan housing portion 30 such that the extending direction of the second fan housing portion 32 makes an approximately 90 degree angle or an acute angle (e.g., angle A1 in FIG. 3) with the extending direction of the first fan housing portion 30. After the user 56 rotates the second fan housing portion 32 to its desired position, the user 56 activates the fan 12 by moving its power switch 26 to the “on” position. The airstream generated by the fan 12 is then directed to a desired portion of the user's body that requires cooling (e.g., a user's torso or face).

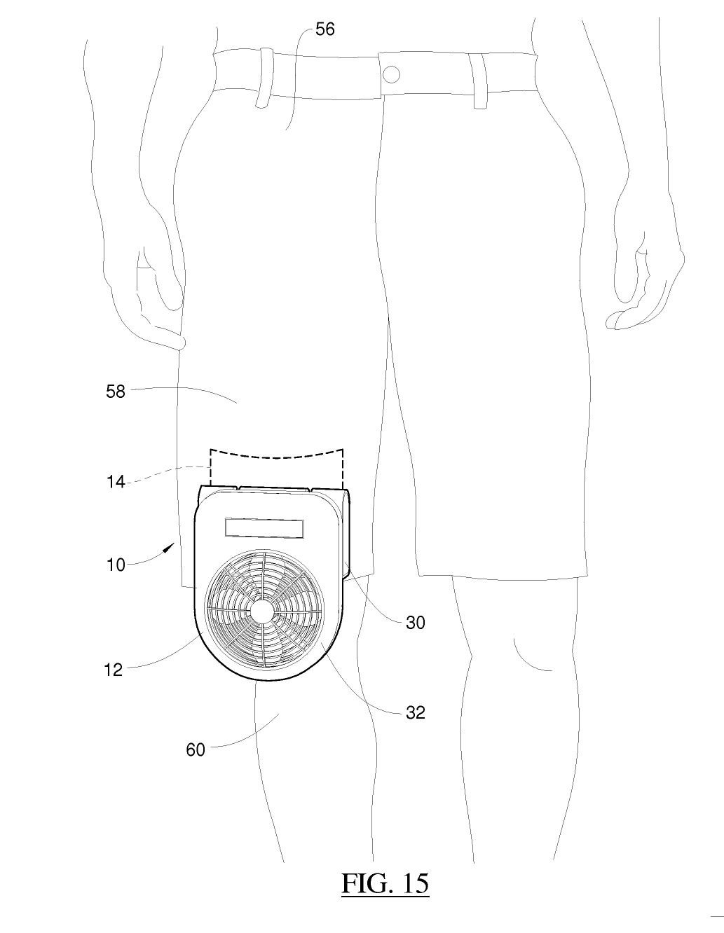

As clearly illustrated in FIG. 15, when the wearable fan assembly 10 is not being used, the second fan housing portion 32 can be conveniently collapsed against the top surface 30a of the first fan housing portion 30 so that the fan assembly 10 occupies less space, thereby making it less obtrusive. This is particularly important when the wearable fan assembly 10 is being utilized in a crowded stadium, where the row-to-row spacing is quite tight. In such a stadium, it is very common for spectators in a particular row to stand up in order to allow another spectator to pass by them. If one of these spectators was utilizing the wearable fan assembly 10, he or she could simply collapse the second fan housing portion 32 against the first fan housing portion 30 before standing up. That way, the fan portion 12 would not hinder the passage of the spectator trying to reach his or her seat. FIG. 15 depicts a user 56 in a standing position with his wearable fan assembly 10 in a collapsed state so as to graphically illustrate the normal arrangement of the fan 12 when it is inactive and its compactness is maximized.

It is readily apparent that the aforedescribed wearable fan assembly 10 offers numerous advantages. First, the wearable fan assembly 10 is capable of being removably attached to an article of clothing 58 worn by a user 56 in a secure manner. Secondly, the wearable fan assembly 10 is both generally unobtrusive and comfortable for a user 56 to wear. In addition, the wearable fan assembly 10 is powerful enough to generate an airflow that can be readily perceived by a user thereof. Finally, the wearable fan assembly 10 is capable of delivering an adjustable stream of air.

Although the invention has been shown and described with respect to a certain embodiment or embodiments, it is apparent that this invention can be embodied in many different forms and that many other modifications and variations are possible without departing from the spirit and scope of this invention.

For example, while the magnets 38 and the metallic plate portion 46 are the preferred means of attachment between the fan portion 12 and the detachable component 14, respectively, it is to be understood that other attachment means have been contemplated by the inventor. In an alternative embodiment of the invention, the bottom surface 30b of the first fan housing portion 30 is provided with one or more apertures and the top surface of the detachable component 14 is provided with one or more pointed protrusions (e.g., pin-like protrusions) extending therefrom, the pointed protrusion(s) being configured to matingly engage with respective aperture(s) in the bottom surface 30b of the first fan housing portion 30 after passing through the fabric of the user's garment. In yet another alternative embodiment, the one or more apertures provided in the bottom surface 30b of the first fan housing portion 30 matingly engage with one or more snaps that are provided on an article of clothing worn by a user. However, unlike the preferred magnets 38, these alternative attachment means introduce safety concerns and interfere with the overall appearance of a user's clothing.

Moreover, as another example, the inventor has contemplated that other power sources can be used to drive the fan motor 24. In particular, rather than using two (2) type D batteries, four (4) type AA batteries could be utilized as the power source of the wearable fan assembly 10. Also, a photovoltaic (PV) power source could be used in lieu of, or in addition to, the two (2) type D batteries that are described in the aforedescribed illustrated embodiment.

Furthermore, while the inclusion of elevating feet 42 is the preferred means for enabling the fan 12 to stably rest on the top surface of furniture, the inventor has also contemplated recessing the magnets 38 into the bottom surface 30b of the first fan housing portion 30, and providing feet that do not have a thickness greater than that of the magnets 38. However, in such an arrangement, it would be more difficult for the recessed magnets to engage with the metallic plate portion 46 on the detachable component 14. Also, the recessed arrangement of the magnets would most likely result in a weaker connection between the fan portion 12 and the detachable component 14.

While exemplary embodiments have been described herein, one of ordinary skill in the art will readily appreciate that the exemplary embodiments set forth above are merely illustrative in nature and should not be construed as to limit the claims in any manner. Rather, the scope of the invention is defined only by the appended claims and their equivalents, and not, by the preceding description.

The invention claimed is:

1. A wearable fan assembly configured to be attached to an article of clothing worn by a user, said wearable fan assembly comprising:
a fan housing having a base portion, said base portion of said fan housing having a bottom surface with at least one magnet disposed thereon;
a power source disposed in said base portion of said fan housing;
a plurality of fan blades pivotally disposed about a rotational axis;
a motor for driving said fan blades during an operational state of said fan assembly, said motor being operatively coupled to said power source in said base portion of said fan housing; and
a detachable component configured to matingly engage with said at least one magnet disposed on said bottom surface of said base portion of said fan housing;
wherein, when said fan assembly is attached to an article of clothing worn by a user, a portion of said article of clothing is sandwiched between a bottom surface of said at least one magnet and a top surface of said detachable component.

2. The wearable fan assembly according to claim 1, wherein said detachable component comprises a curved plate.

3. The wearable fan assembly according to claim 2, wherein said curved plate of said detachable component has a curvature that approximately matches the outer curvature of a limb of said user.

4. The wearable fan assembly according to claim 2, wherein said curved plate of said detachable component is formed from a flexible polymeric material.

5. The wearable fan assembly according to claim 2, wherein said detachable component further comprises a metallic material that is magnetically attracted to said at least one magnet, said metallic material being disposed adjacent to a bottom surface of said curved plate.

6. The wearable fan assembly according to claim 5, wherein said detachable component further comprises a backing material substantially covering said bottom surface of said curved plate and a bottom surface of said metallic material.

7. The wearable fan assembly according to claim 6, wherein said backing material comprises one of the following: (i) a felt material; (ii) a foam material; and (iii) a sponge material.

8. The wearable fan assembly according to claim 5, wherein said curved plate has an aperture disposed therethrough and said metallic material is positioned behind said aperture.

9. The wearable fan assembly according to claim 8, wherein said aperture is smaller in size as compared to said metallic material such that said curved plate overlaps said metallic material on a plurality of its sides, thereby forming a lip.

10. The wearable fan assembly according to claim 9, wherein a top surface of said curved plate is substantially flush with a top surface of said metallic material along at least one outer edge of said metallic material so that said detachable component and said fan housing are capable of being easily detached from one another.

11. The wearable fan assembly according to claim 2, wherein said curved plate has either (i) double-stick tape or (ii) hook-and-loop fasteners disposed on a top surface thereof so that said detachable component is capable of being removably attached to said article of clothing.

12. The wearable fan assembly according to claim 1, wherein said at least one magnet comprises two magnets, each being circular in shape.

13. The wearable fan assembly according to claim 12, wherein each of said two magnets is attached to said bottom surface of said fan housing by means of a screw.

14. The wearable fan assembly according to claim 12, wherein each of said two magnets is attached to said bottom surface of said fan housing by means of an adhesive.

15. The wearable fan assembly according to claim 1, wherein said bottom surface of said fan housing further includes a plurality of feet disposed thereon for enabling the fan assembly to stably rest on a tabletop.

16. The wearable fan assembly according to claim 15, wherein said bottom surface of said at least one magnet is disposed at a higher elevation than a bottom surface of each of said plurality of feet so that said at least one magnet does not affect the stability of said fan assembly when it is resting on said tabletop.

17. The wearable fan assembly according to claim 1, wherein said power source disposed in said base portion of said fan housing comprises one or more batteries.

18. The wearable fan assembly according to claim 17, further comprising a power switch for selectively regulating the flow of current from said one or more batteries to said motor.

19. The wearable fan assembly according to claim 1, further comprising a power receptacle on said base portion of said fan housing for receiving a plug of an alternating current-to-direct current (AC-to-DC) power adapter.

20. A wearable fan assembly configured to be attached to an article of clothing worn by a user, said wearable fan assembly comprising:
a first fan housing portion, said first fan housing portion having a top surface, a bottom surface disposed opposite to said top surface, and a plurality of side surfaces extending between said bottom surface and said top surface, said bottom surface of said first fan housing portion having at least one magnet disposed thereon;
a power source disposed in said first fan housing portion;
a second fan housing portion rotatably connected to said first fan housing portion;
a plurality of fan blades pivotally disposed about a rotational axis, said plurality of fan blades circumscribed by said second fan housing portion;
a motor for driving said fan blades during an operational state of said fan assembly, said motor being operatively coupled to said power source in said first fan housing portion;
a detachable component configured to be disposed underneath said bottom surface of said first fan housing portion when said fan assembly is in said operational state, said detachable component comprising a material that is magnetically attracted to said at least one magnet of said first fan housing portion;
wherein, when said fan assembly is attached to an article of clothing worn by a user, said bottom surface of said first fan housing portion is configured to be disposed adjacent to an outer surface of said article of clothing, and a top surface of said detachable component is configured to be disposed adjacent to an inner surface of said article of clothing; and
wherein said rotational axis of said plurality of fan blades is capable of being oriented in a direction that is substantially parallel to an extending direction of said bottom surface of said first fan housing portion when said fan assembly is in said operational state.

21. A wearable fan assembly configured to be attached to an article of clothing worn by a user, said wearable fan assembly comprising:
a fan housing having a base portion, said base portion of said fan housing having a bottom surface with at least one attachment member disposed thereon;
a power source disposed in said base portion of said fan housing;
a plurality of fan blades pivotally disposed about a rotational axis;
a motor for driving said fan blades during an operational state of said fan assembly, said motor being operatively coupled to said power source in said base portion of said fan housing; and
a detachable component configured to matingly engage with said at least one attachment member disposed on said bottom surface of said base portion of said fan housing;
wherein, when said fan assembly is attached to an article of clothing worn by a user, a portion of said article of clothing is sandwiched between a bottom surface of said at least one attachment member and a top surface of said detachable component.

22. A method for convectively cooling a user that utilizes a wearable fan assembly, said method comprising the steps of:
providing a wearable fan assembly configured to be attached to an article of clothing worn by a user, said wearable fan assembly including:
a fan housing having a base portion, said base portion of said fan housing having a bottom surface with at least one magnet disposed thereon;
a power source disposed in said base portion of said fan housing;
a plurality of fan blades pivotally disposed about a rotational axis;
a motor for driving said fan blades during an operational state of said fan assembly, said motor being operatively coupled to said power source in said base portion of said fan housing;
a power switch for selectively regulating the flow of current from said power source to said motor, said power switch disposed on said base portion of said fan housing; and
a detachable component configured to matingly engage with said at least one magnet disposed on said bottom surface of said base portion of said fan housing;
positioning said detachable component of said wearable fan assembly on a limb of said user and underneath said article of clothing worn by said user;
positioning said at least one magnet disposed on said bottom surface of said base portion of said fan housing in close proximity to said detachable component such that said at least one magnet matingly engages with said detachable component, thereby sandwiching a portion of said article of clothing worn by said user between a bottom surface of said at least one magnet and a top surface of said detachable component; and
activating said wearable fan assembly by moving said power switch disposed on said base portion of said fan housing to its “on” position, thereby generating airflow for convectively cooling said user.
